(19) United States
(12) Patent Application Publication
(10) Pub. No.: US 2017/0086278 A1
(43) Pub. Date: Mar. 23, 2017

(54) ELECTRONIC DEVICE, CONTROL METHOD OF ELECTRONIC DEVICE, NON-TRANSITORY STORAGE MEDIUM OF ELECTRONIC DEVICE, AND CONTROL SYSTEM OF ELECTRONIC DEVICE

(71) Applicant: KYOCERA Corporation, Kyoto-shi, Kyoto (JP)

(72) Inventor: Atsushi YAMAUCHI, Yokohama-shi, Kanagawa (JP)

(21) Appl. No.: 15/311,583

(22) PCT Filed: May 20, 2015
(86) PCT No.: PCT/JP2015/064517

§ 371 Date: Nov. 16, 2016

(30) Foreign Application Priority Data
May 22, 2014 (JP) 2014-105773

(51) Int. Cl. H05B 37/02; H05B 33/08

(52) U.S. Cl. CPC H05B 37/0227; H05B 33/0854; H05B 37/0281

(57) ABSTRACT

An electronic device comprises at least one controller configured to determine a moving state of a user from a plurality of moving states and to bring a light emitter into a lighting-on state depending on the determined moving state.

### CROSS-REFERENCE TO RELATED APPLICATION

This application is a national stage of PCT International Application No. PCT/JP2015/064517 filed in Japan on May 20, 2015, which claims priority to and incorporates by reference the entire contents of Japanese Patent Application No. 2014-105773 filed in Japan on May 22, 2014.

### FIELD

The present disclosure relates to an electronic device, a control method of an electronic device, a non-transitory storage medium of an electronic device, and a control system of an electronic device.

### BACKGROUND

According to Japanese Patent Application Laid-open No. 2007-47844, a known communication terminal performs steady light control based on a position of a pedestrian detected by GPS.

### SUMMARY

An electronic device, a control method of an electronic device, a non-transitory storage medium of an electronic device, and a control system of an electronic device are disclosed.

According to one aspect, there is provided an electronic device, comprising at least one controller configured to determine a moving state of a user from a plurality of moving states and to bring a light emitter into a lighting-on state depending on the determined moving state.

According to one aspect, there is provided a control method of an electronic device, the control method comprising determining, by at least one controller, a moving state from a plurality of moving states, and bringing, by the at least one controller, a light emitter into a lighting-on state depending on the determined moving state.

According to one aspect, there is provided a non-transitory storage medium that stores a control program of an electronic device for causing a controller to execute determining a moving state from a plurality of moving states, and bringing a light emitter into a lighting-on state depending on the determined moving state.

According to one aspect, there is provided a control system of an electronic device, comprising a light emitter, and at least one controller configured to determine a moving state of a user from a plurality of moving states and to bring the light emitter into a lighting-on state depending on the determined moving state.

### BRIEF DESCRIPTION OF THE DRAWINGS

FIG. 1 is a block diagram illustrating a functional configuration of a mobile phone.

FIG. 2 is a chart schematically illustrating results of detection by an acceleration sensor.

FIG. 3 is a block diagram illustrating a functional configuration of a mobile phone according to a modification.

FIG. 4 is a block diagram illustrating a functional configuration of a mobile phone according to another modification.

FIG. 5A is a front view schematically illustrating an appearance configuration of a mobile phone 1.

FIG. 5B is a front view schematically illustrating an appearance configuration of a mobile phone 2.

FIG. 5C is a front view schematically illustrating an appearance configuration of a mobile phone 3.

FIG. 6 is a first flowchart illustrating steps of a process for determining a moving state in the mobile phone 3.

FIG. 7 is a second flowchart illustrating steps of an exemplary process for bringing a light emitter of the mobile phone 3 into lighting-on/lighting-off state.

FIG. 8 is a third flowchart illustrating steps of another exemplary process for bringing the light emitter of the mobile phone 3 into lighting-on/lighting-off state.

FIG. 9 is a fourth flowchart illustrating steps of still another exemplary process for bringing the light emitter of the mobile phone 3 into lighting-on/lighting-off state.

FIG. 10 is a front view schematically illustrating a digital wristwatch 4.

### DETAILED DESCRIPTION OF THE PREFERRED EMBODIMENTS

The following describes an exemplary embodiment in detail while referring to the accompanying drawings. A mobile phone will hereinafter be described as an exemplary electronic device.

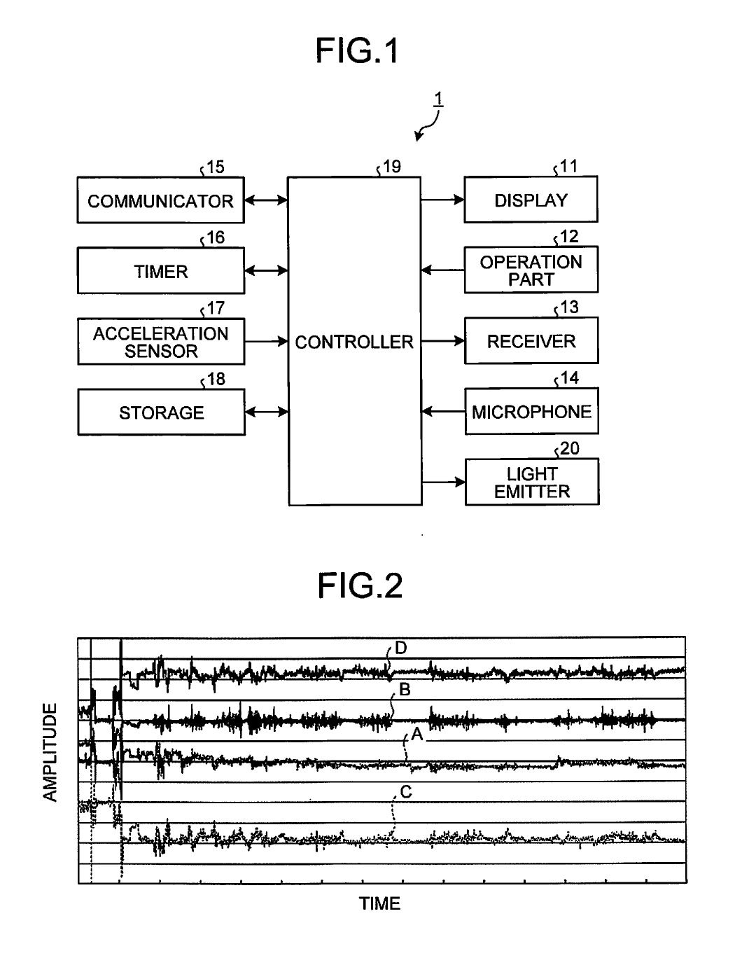

FIG. 1 is a block diagram illustrating a functional configuration of a mobile phone.

This mobile phone 1 includes, as illustrated in FIG. 1, a display 11, an operation part 12, a receiver 13, a microphone 14, a communicator 15, a timer 16, an acceleration sensor 17, a storage 18, a controller 19, and a light emitter 20.

The display 11 may be configured by a display device, such as, for example, a liquid crystal display (LCD), an electroluminescence (EL) display, and a micro electromechanical system (MEMS) shutter display.

The operation part 12 includes a plurality of buttons. It is noted that the operation part 12 may include a single button or a touch screen. The operation part 12 is operated by a user. Use of the operation part 12 allows the user to input a signal to the controller 19 to operate the mobile phone 1.

The receiver 13 converts a sound signal transmitted from the controller 19 to a corresponding sound and outputs the sound.

The microphone 14 inputs a sound to the controller 19.

The communicator 15 includes an antenna and an RF circuit. The communicator 15 can perform communication with another communication device in accordance with a communication scheme corresponding to one of a plurality of wireless communication standards. The communicator 15 may perform communication with another communication device in accordance with a cellular phone communication standard, such as 2G, 3G, or 4G, or a wireless LAN system. The communicator 15 may perform communication with another communication device in accordance with a wireless communication system base on IEEE802.11 as a wireless LAN system, for example, a WiFi (a registered trademark) wireless communication system. It is noted that the communicator 15 may perform communication with another communication device in accordance with a WiMAX (a registered trademark) or WiMAX2+ (a registered trademark) wireless communication system. The antenna and the RF circuit may be provided to correspond to each of the communication schemes. In some embodiments, the communicator 15 will be described to perform communication with another communication device in accordance with a cellular phone communication standard.

The timer 16 is connected with the controller 19. By applying an interrupt signal to the controller 19 at regular intervals, the timer 16 allows the controller 19 to perform a regular operation and a synchronizing operation.

The acceleration sensor 17 detects a direction and magnitude of acceleration acting on the mobile phone 1 and outputs detection results to the controller 19. For the acceleration sensor 17, a 3G (three dimensional) type that detects acceleration in an X-axis direction, a Y-axis direction, and a Z-axis direction may be used.

Examples of the acceleration sensor 17 in terms of a detection principle thereof include, but are not limited to, a piezo resistance type, a capacitance type, and a heat detection type.

The storage 18 is used for arithmetic operations by the controller 19. The storage 18 includes, for example, a nonvolatile memory. The storage 18 stores various types of computer programs. Examples of the computer programs stored in the storage 18 include, but are not limited to, control programs for controlling different parts of the mobile phone 1 and various types of application programs (hereinafter referred to simply as “applications”). Examples of the applications include, but are not limited to, telephone, messaging, web browser, maps, games, and schedule management applications.

It is noted that the various types of computer programs are stored in the storage 18 during manufacturing of the mobile phone 1 by a manufacturer. The various types of computer programs may be stored in the storage 18 via a communication network or a recording medium, such as a memory card and a CD-ROM.

The controller 19 controls the mobile phone 1 totally. The controller 19 includes a central processing unit (CPU) and a micro-processing unit (MPU). The controller 19 can perform various types of processings by the computer programs stored in the storage 18.

The following describes processing performed by the controller 19 to process results of detection by the acceleration sensor 17.

FIG. 2 is a chart schematically illustrating the results of detection by the acceleration sensor.

As illustrated in FIG. 2, the controller 19 receives, as the results of detection by the acceleration sensor 17, inputs of acceleration in the X-axis direction (denoted A in FIG. 2), acceleration in the Y-axis direction (denoted B in FIG. 2), acceleration in the Z-axis direction (denoted C in FIG. 2), and a vector value (denoted D in FIG. 2) that combines the foregoing acceleration values. The controller 19 logs the combined vector value that represents the input acceleration values combined with each other. The controller 19 analyzes the logged data to determine a moving state of the user. The logged data may be stored in the storage 18.

When determining the moving state of the user, the controller 19 can use acceleration patterns. The acceleration patterns are, for example, stored in the storage 18 in advance. Each of the acceleration patterns is associated with a specific moving state. Each of the acceleration pattern represents a pattern previously measured and extracted as a characteristic acceleration pattern by the acceleration sensor 17 depending on a specific moving state of the user who holds the mobile phone 1. Examples of the moving states of the user include, but are not limited to, a state of the user who remains stationary (hereinafter also referred to as a stationary state), a state of the user who is moving by walking (hereinafter also referred to as a walking state), and a state of the user who is moving by running (hereinafter also referred to as a running state). The storage 18 may previously stores various acceleration patterns, each of which corresponding to a specific moving state. The controller 19 compares logged data of the combined vector values with each of the acceleration patterns to determine the moving state of the user.

The controller 19 may determine, instead of the acceleration pattern representing the stationary state, a case in which an acceleration value detected by the acceleration sensor 17 is smaller than a predetermined value to be the stationary state. The controller 19 may determine, instead of the acceleration pattern representing the stationary state, a case in which the logged data of the combined vector values does not match any of the stored acceleration patterns to be the stationary state.

It is noted that the controller 19 can repeatedly determine the moving state at every predetermined time interval and store results of the determination in the storage 18. Specifically, the controller 19 is capable of continuously determining the moving state. When storing the results of the determination of the moving state, the controller 19 may replace an older determination result with a latest determination result or accumulate the determination results. When the controller 19 accumulates the determination results and when the accumulated determination results reach a predetermined amount, older accumulated determination results may be deleted.

The light emitter 20 includes a light emitting element, such as a light emitting diode (LED). The controller 19 can control emission timing of the light emitting element of the light emitter 20. Specifically, the controller 19 can bring the light emitter 20 into a lighting-off state or a lighting-on state. The lighting-off state includes a state in which the light emitting element of the light emitter 20 does not emit light. The lighting-on state includes a state in which the light emitting element of the light emitter 20 emits light continuously or in which the light emitting element flashes at predetermined time intervals. The light emitter 20 may be disposed at a position at which the light emitter 20 is not expected to be covered by a body of the user when the user wears the mobile phone 1.

The controller 19 brings the light emitter 20 into the lighting-on state depending on the moving state determined.

The mobile phone 1 includes the controller 19 that determines a specific moving state selected from a plurality of the moving states of the user and, depending on the determined moving state, brings the light emitter 20 into the lighting-on state. The mobile phone 1 can adjust emission timing at which the light emitter 20 emits light depending on the moving state. For example, the controller 19, upon determining that the moving state is the walking state or the running state, performs control to bring the light emitter 20 into the lighting-on state. When the determined moving state changes from the stationary state to the walking state or from the stationary state to the running state, the controller 19 can bring the light emitter 20 into the lighting-on state. The mobile phone 1 including the controller 19 as described above can be used in a condition in which the user wears the mobile phone 1 and walk or jog in a dark environment outside. Specifically, when the user enters the walking state or the running state from the stationary state and the light emitter 20 is in the lighting-off state, the mobile phone 1 allows the light emitter 20 to enter the lighting-on state without using the operation part 12. It is noted that the user can wear the mobile phone 1 that is held in a condition of being exposed to the outside such that the light of the light emitter 20 is visible to others (hereinafter referred to simply as “wear”). The user may use a holder, such as a strap or a belt, to wear the mobile phone 1.

In some embodiments, the controller 19, after having brought the light emitter 20 into the lighting-on state, may maintain the lighting-on state until a predetermined input through the operation part 12 is detected. This arrangement allows the light emitter 20 to maintain the lighting-on state even when the moving state determined by the controller 19 changes after the lighting-on state of the light emitter 20. An exemplary situation in which the moving state determined by the controller 19 changes may be a situation that a user who is walking comes to a standstill to wait for a traffic light. That is, the moving state determined by the controller 19 changes from the walking state to the stationary state at the exemplary situation. With the mobile phone 1 that can maintain the light emitter 20 in the lighting-on state even when the moving state determined by the controller 19 changes, the light emitter 20 does not easily change from the lighting-on state to the lighting-off state at timing that is not expected by the user.

The mobile phone 1 may further include a proximity sensor. Examples of the proximity sensor include, but are not limited to, an induction type sensor, a capacitance type sensor, an ultrasonic type sensor, and an infrared type sensor. The induction type sensor can detect changes in a magnetic field. The capacitance type sensor can detect changes in capacitance. The ultrasonic type sensor can detect a reflected wave of an ultrasonic wave. The infrared type sensor can detect an infrared ray. With the proximity sensor, the controller 19 may determine whether an object exists within a predetermined distance away from the proximity sensor based on a value detected by the proximity sensor. When it is determined that no object exists within the predetermined distance away from the proximity sensor, the controller 19 may bring the light emitter 20 into the lighting-on state depending on the moving state. The foregoing arrangement can prevent the light emitter 20 from being brought into the lighting-on state in a predetermined environment, for example, an environment in which the mobile phone 1 is covered with a case.

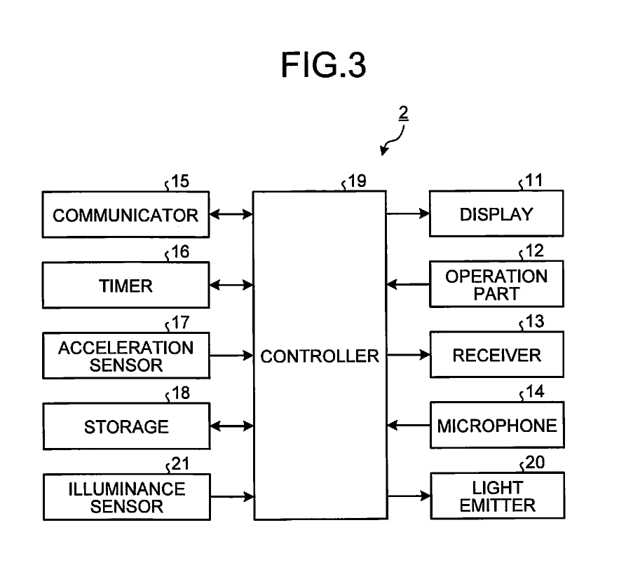

FIG. 3 is a block diagram illustrating a functional configuration of a mobile phone according to a modification. In the following, the same elements are identified by the same reference numerals and duplicate descriptions may be omitted.

As illustrated in FIG. 3, this mobile phone 2 includes a display 11, an operation part 12, a receiver 13, a microphone 14, a communicator 15, a timer 16, an acceleration sensor 17, a storage 18, a controller 19, a light emitter 20, and an illuminance sensor 21.

The illuminance sensor 21 converts light incident upon the illuminance sensor 21 to a corresponding current and outputs the resulting current to the controller 19. The controller 19 monitors the current that is input from the illuminance sensor 21. When an amount of current to be monitored is greater than a predetermined current threshold, the controller 19 determines that the environment state is a bright state. When the amount of current to be monitored is smaller than the predetermined current threshold, the controller 19 determines that the environment state is a dark state. The current threshold may be set as appropriate. Examples of the illuminance sensor 21 include, but are not limited to, a phototransistor, a photodiode, and a photodiode including an amplifier added thereto. The illuminance sensor 21 may be disposed at a position at which the illuminance sensor 21 is not covered by a body of the user when the user wears the mobile phone 2.

The controller 19 determines at least one of the walking state or the running state for the moving states. Upon determining that the environment state has changed from the bright state to the dark state based on the current value detected by the illuminance sensor 21 when the moving state is determined to be the walking state or the running state, the controller 19 can bring the light emitter 20 into the lighting-on state. The mobile phone 2 that includes the controller 19 as described above is capable of controlling the emission of the light more conveniently even in an environment in which the user walks or jogs during a time period of a day from bright to dark outside. Specifically, in a case where the user is in the walking state or the running state when it is still bright outside, the mobile phone 2 can bring the light emitter 20 into the lighting-off state. In a case where it turns dark outside when the user is in the walking state or the running state, the mobile phone 2 can bring the light emitter 20 into the lighting-on state. The mobile phone 2 can readily bring the light emitter 20 into the lighting-on state without using the operation part 12.

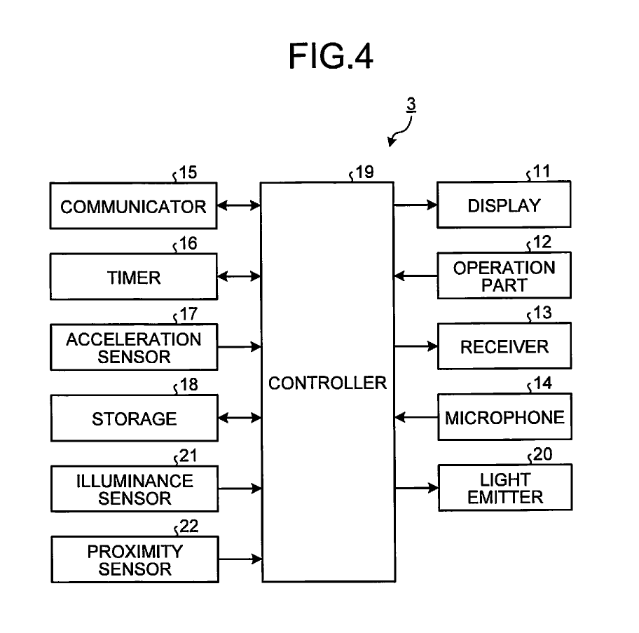

FIG. 4 is a block diagram illustrating a functional configuration of a mobile phone according to another modification.

As illustrated in FIG. 4, this mobile phone 3 includes a display 11, an operation part 12, a receiver 13, a microphone 14, a communicator 15, a timer 16, an acceleration sensor 17, a storage 18, a controller 19, a light emitter 20, an illuminance sensor 21, and a proximity sensor 22 as the proximity sensor described previously.

The proximity sensor 22 is disposed in a main body of the mobile phone 3 that includes the illuminance sensor 21. The proximity sensor 22 may be disposed at a position at which the proximity sensor 22 is not covered by a body of the user when the user wears the mobile phone 3.

The controller 19 of the mobile phone 3 can determine whether the environment is in a bright state or a dark state based on the value detected by the illuminance sensor 21. The controller 19 can determine whether an object exists within a predetermined distance away from the proximity sensor 22 based on the value detected by the proximity sensor 22. Upon determining that the environment state is the dark state and that no object exists within the predetermined distance away from the proximity sensor 22, the controller 19 can bring the light emitter 20 into the lighting-on state depending on the moving state. With the foregoing arrangements, the controller 19 can prevent the light emitter 20 from entering the lighting-on state even when it determines that the environment state is the dark state under a condition in which an object exists within the predetermined distance away from the proximity sensor 22. For example, when the user puts the mobile phone 3 in a pocket of his or her clothing when he/she is determined to be in the walking state or the running state, the controller 19 can prevent the light emitter 20 from entering the lighting-on state.

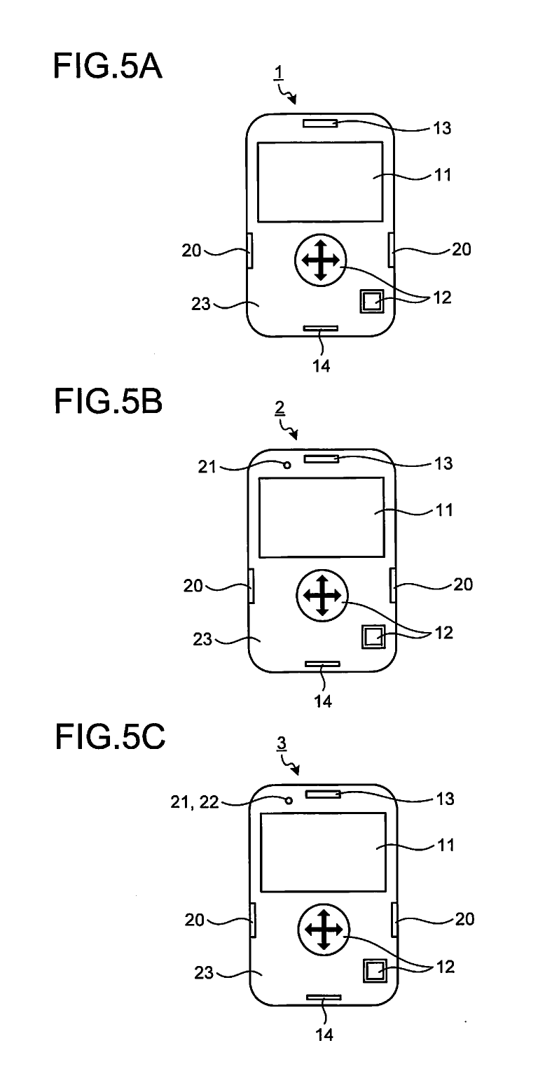

FIG. 5A is a front view schematically illustrating an appearance configuration of the mobile phone 1. FIG. 5B is a front view schematically illustrating an appearance configuration of the mobile phone 2. FIG. 5C is a front view schematically illustrating an appearance configuration of the mobile phone 3.

The mobile phone 1 illustrated in FIG. 5A includes a main body 23. The main body 23 includes the display 11, the operation part 12, the receiver 13, the microphone 14, and the light emitter 20.

The mobile phone 2 illustrated in FIG. 5B includes a main body 23. The main body 23 includes the display 11, the operation part 12, the receiver 13, the microphone 14, the light emitter 20, and the illuminance sensor 21.

The mobile phone 3 illustrated in FIG. 5C includes a main body 23. The main body 23 includes the display 11, the operation part 12, the receiver 13, the microphone 14, the light emitter 20, the illuminance sensor 21, and the proximity sensor 22. The illuminance sensor 21 and the proximity sensor 22 are configured into a combined sensor in which an illuminance sensor and a proximity sensor are integrated.

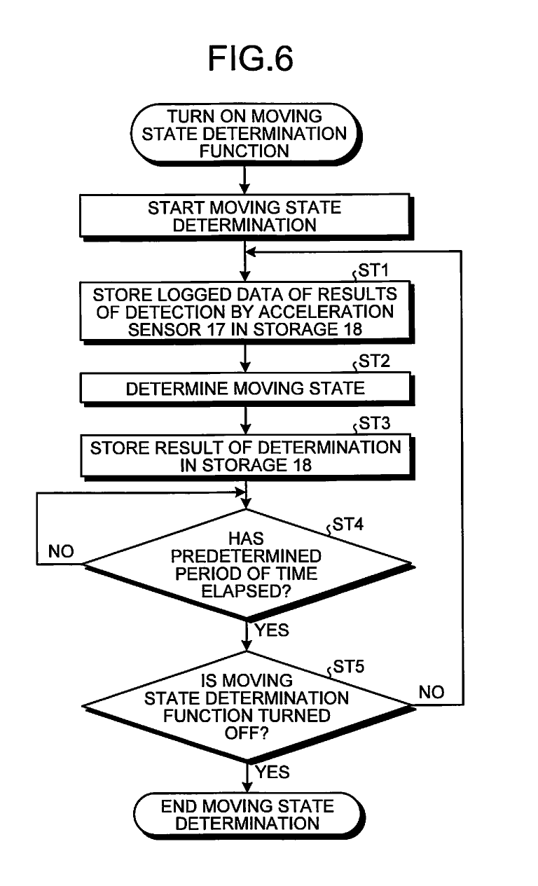

The following describes operations of the mobile phone 3 with reference to flowcharts illustrated in FIGS. 6 to 9.

FIG. 6 is a first flowchart illustrating steps of a process for determining the moving state, performed by the mobile phone 3.

When a moving state determination function is turned ON, the controller 19 starts determining the moving state. The moving state determination function may be turned ON using the operation part 12.

When the moving state determination is started, the controller 19 starts logging results of detection by the acceleration sensor 17 at Step ST1. The controller 19 stores the logged data in the storage 18 and proceeds to Step ST2.

At Step ST2, the controller 19 analyzes the results of detection by the acceleration sensor 17 to determine a moving state and proceeds to Step ST3.

At Step ST3, the controller 19 stores the result of the determination for the moving state in the storage 18 and proceeds to Step ST4.

At Step ST4, the controller 19 determines whether a predetermined period of time has elapsed. When it is determined that the predetermined period of time has elapsed (Yes), the controller 19 proceeds to Step ST5. When it is determined that the predetermined period of time has not elapsed (No), the controller 19 repeats Step ST4. Preferably, the predetermined period of time is short.

At Step ST5, the controller 19 determines whether the moving state determination function is OFF. When it is determined that the moving state determination function is turned OFF (Yes), the controller 19 terminates the process for determining the moving state. When it is determined that the moving state determination function is not turned OFF (No), the controller 19 returns to Step ST1.

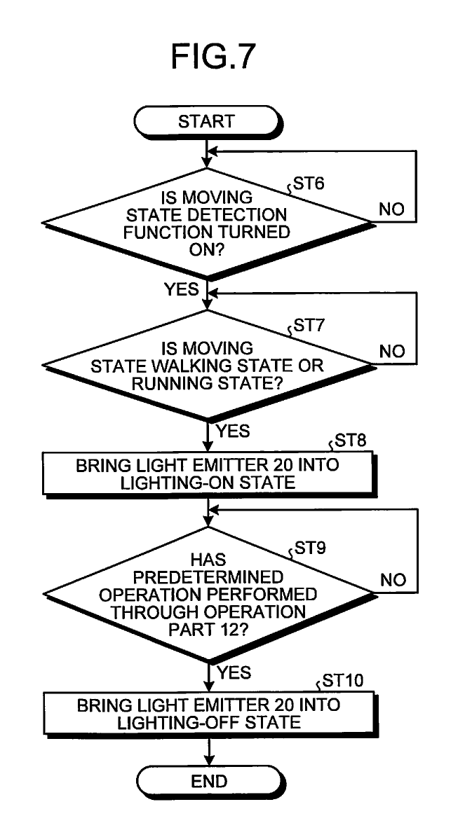

FIG. 7 is a second flowchart illustrating exemplary steps of a process for bringing the light emitter 20 of the mobile phone 3 into lighting-on/lighting-off state. The process illustrated in the second flowchart is performed independently of the process illustrated in the first flowchart.

At Step ST6, the controller 19 determines whether a moving state detection function is turned ON. When it is determined that the moving state detection function is turned ON (Yes), the controller 19 proceeds to Step ST7. When it is determined that the moving state detection function is not turned ON (No), the controller 19 repeats Step ST6.

At Step ST7, the controller 19 determines whether the moving state is determined to be the walking state or the running state. When it is determined that the moving state is determined to be the walking state or the running state (Yes), the controller 19 proceeds to Step ST8. When it is determined that the moving state is not determined to be the walking state or the running state (No), the controller 19 repeats to Step ST7.

At Step ST8, the controller 19 brings the light emitter 20 into the lighting-on state and proceeds to Step ST9. The mobile phone 3 that performs such a process for bringing the light emitter 20 into the lighting-on state can adjust emission timing at which the light emitter 20 emits light depending on the moving state.

At Step ST9, the controller 19 determines whether a predetermined operation has been performed through the operation part 12. When it is determined that the predetermined operation has been performed through the operation part 12 (Yes), the controller 19 proceeds to Step ST10. When it is determined that the predetermined operation has not been performed through the operation part 12 (No), the controller 19 repeats Step ST9.

At Step ST10, the controller 19 brings the light emitter 20 into the lighting-off state and completes the process. With the mobile phone 3, even when the moving state determined by the controller 19 changes after the light emitter 20 has been brought into the lighting-on state, the light emitter 20 can maintain the lighting-on state until the predetermined operation is performed through the operation part 12. In the mobile phone 3, the light emitter 20 does not easily change from the lighting-on state to the lighting-off state at a timing that is not expected by the user.

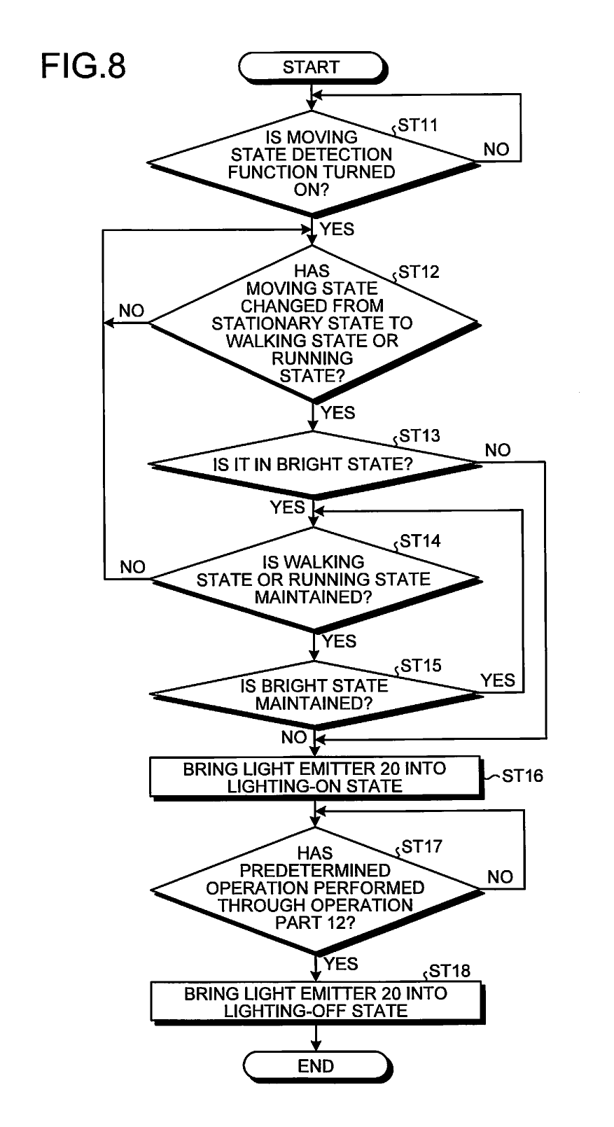

FIG. 8 is a third flowchart illustrating steps of another exemplary process for bringing the light emitter 20 of the mobile phone 3 into lighting-on/lighting-off state. The process illustrated in the third flowchart is performed independently of the process illustrated in the first flowchart.

At Step ST11, the controller 19 determines whether the moving state detection function is turned ON. When it is determined that the moving state detection function is turned ON (Yes), the controller 19 proceeds to Step ST12. When it is determined that the moving state detection function is not turned ON (No), the controller 19 repeats Step ST11.

At Step ST12, the controller 19 determines whether the moving state changes from a state other than the walking state or the running state, for example, the stationary state to the walking state or the running state. When it is determined that the moving state changes from the stationary state to the walking state or the running state (Yes), the controller 19 proceeds to Step ST13. When it is determined that the moving state does not change from the stationary state to the walking state or the running state (No), the controller 19 repeats Step ST12.

At Step ST13, the controller 19 determines based on an amount of current detected by the illuminance sensor 21 whether it is in a bright state. When it is determined that it is in the bright state (Yes), the controller 19 proceeds to Step ST14. When it is determined that the it is not in the bright state (No), the controller 19 proceeds to Step ST16.

At Step ST14, the controller 19 determines whether the moving state is maintained as the walking state or the running state. When it is determined that the moving state is maintained as the walking state or the running state (Yes), the controller 19 proceeds to Step ST15. When it is determined that the moving state is not maintained as the walking state or the running state (No), the controller 19 proceeds to Step ST12.

At Step ST15, the controller 19 determines based on the amount of the current detected by the illuminance sensor 21 whether the bright state is maintained. When it is determined that the bright state is not maintained (No), the controller 19 proceeds to Step ST16. When it is determined that the bright state is maintained (Yes), the controller 19 proceeds to Step ST14.

At Step ST16, the controller 19 brings the light emitter 20 into the lighting-on state and proceeds to Step ST17.

At Step ST17, the controller 19 determines whether a predetermined operation has been performed through the operation part 12. When it is determined that the predetermined operation has been performed through the operation part 12 (Yes), the controller 19 proceeds to Step ST18. When it is determined that the predetermined operation has not been performed through the operation part 12 (No), the controller 19 repeats Step ST17.

At Step ST18, the controller 19 brings the light emitter 20 into the lighting-off state and completes the process.

The mobile phone 3 that performs such a process for bringing the light emitter 20 into lighting-on state can readily bring the light emitter 20 into the lighting-on state even under a moving state (the walking state or the running state) in which bringing the light emitter 20 into the lighting-on state using the operation part 12 is difficult.

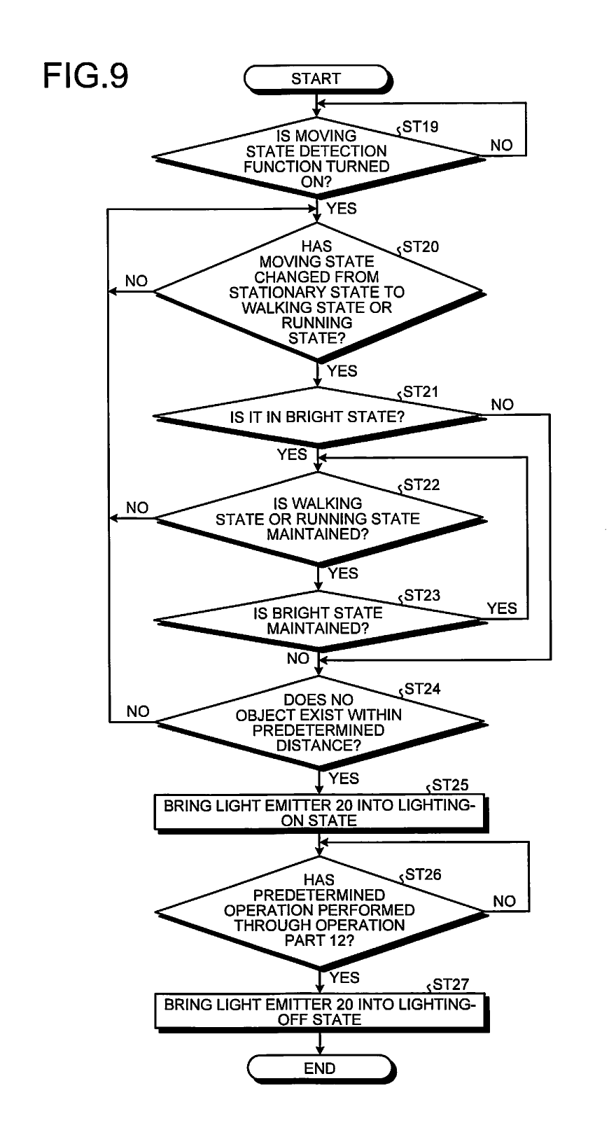

FIG. 9 is a fourth flowchart illustrating steps of still another exemplary process for bringing the light emitter 20 of the mobile phone 3 into lighting-on/lighting-off state. The process illustrated in the fourth flowchart is performed independently of the process illustrated in the first flowchart.

At Step ST19, the controller 19 determines whether the moving state detection function is turned ON. When it is determined that the moving state detection function is turned ON (Yes), the controller 19 proceeds to Step ST20. When it is determined that the moving state detection function is not turned ON (No), the controller 19 repeats Step ST19.

At Step ST20, the controller 19 determines whether the moving state changes from the stationary state to the walking state or the running state. When it is determined that the moving state changes from the stationary state to the walking state or the running state (Yes), the controller 19 proceeds to Step ST21. When it is determined that the moving state does not change from the stationary state to the walking state or the running state (No), the controller 19 repeats Step ST20.

At Step ST21, the controller 19 determines based on an amount of current detected by the illuminance sensor 21 whether it is in a bright state. When it is determined that it is in the bright state (Yes), the controller 19 proceeds to Step ST22. When it is determined that it is not in the bright state (No), the controller 19 proceeds to Step ST24.

At Step ST22, the controller 19 determines whether the moving state is maintained as the walking state or the running state. When it is determined that the moving state is maintained as the walking state or the running state (Yes), the controller 19 proceeds to Step ST23. When it is determined that the moving state is not maintained as the walking state or the running state (No), the controller 19 proceeds to Step ST20.

At Step ST23, the controller 19 determines based on the amount of the current detected by the illuminance sensor 21 whether the bright state is maintained. When it is determined that the bright state is not maintained (No), the controller 19 proceeds to Step ST24. When it is determined that the bright state is maintained (Yes), the controller 19 proceeds to Step ST22.

At Step ST24, the controller 19 determines based on a value detected by the proximity sensor 22 whether no object exists within a predetermined distance away from the proximity sensor 22. When it is determined that no object exists within the predetermined distance (Yes), the controller 19 proceeds to Step ST25. When it is determined that an object exists within the predetermined distance (No), the controller 19 proceeds to Step ST20.

At Step ST25, the controller 19 brings the light emitter 20 into the lighting-on state and proceeds to Step ST26.

At Step ST26, the controller 19 determines whether a predetermined operation has been performed through the operation part 12. When it is determined that the predetermined operation has been performed through the operation part 12 (Yes), the controller 19 proceeds to Step ST27. When it is determined that the predetermined operation has not been performed through the operation part 12 (No), the controller 19 repeats Step ST26.

At Step ST27, the controller 19 brings the light emitter 20 into the lighting-off state and completes the process.

The mobile phone 3 that brings the light emitter 20 into the lighting-on state through the foregoing operation can prevent the light emitter 20 from entering the lighting-on state even when the controller 19 determines that the environment state is the dark state under a condition in which an object exists within the predetermined distance away from the proximity sensor 22.

Each of the mobile phones 1 to 3 according to the embodiments includes the acceleration sensor 17, the controller 19, and the light emitter 20 integrally. Alternatively, a plurality of electronic devices may cooperate with each other as a system that brings the light emitter 20 into the lighting-on state depending on the moving state. When the electronic devices cooperate with each other to function as a system, a controller included in each of the electronic devices may cooperate with each other to determine the moving state and thereby cause the light emitter 20 to emit light.

The electronic device according to the present disclosure has been described as the mobile phones 1 to 3. Alternatively, the electronic device according to the present disclosure may be a digital wristwatch.

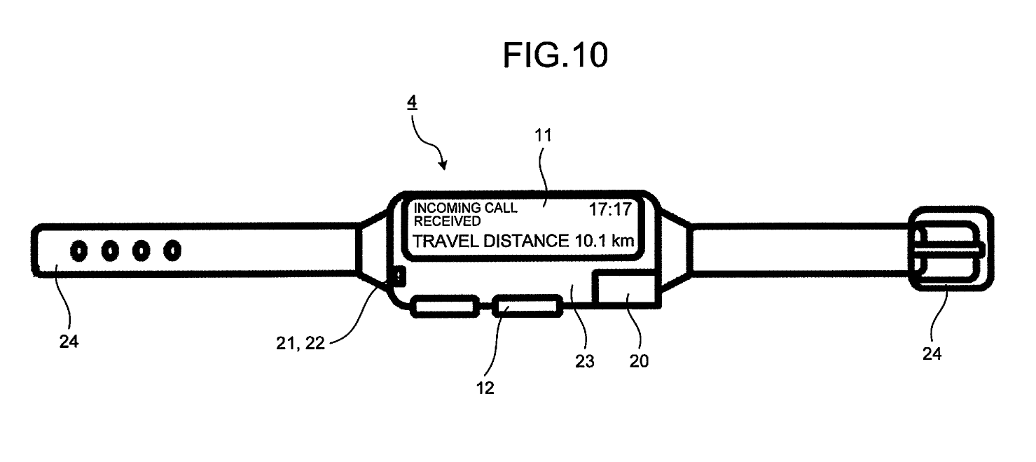

FIG. 10 is a front view schematically illustrating a digital wristwatch 4.

As illustrated in FIG. 10, the digital wristwatch 4 includes a display 11 and operation parts 12 disposed on a main body 23. The digital wristwatch 4 further includes a light emitter 20, an illuminance sensor 21, and a proximity sensor 22 disposed on the main body 23. The illuminance sensor 21 and the proximity sensor 22 are configured into a combined sensor in which an illuminance sensor and a proximity sensor are integrated. The main body 23 includes a holder 24 that is wrapped around a wrist of a user. The digital wristwatch 4 further includes, although not illustrated, a communicator 15, a timer 16, an acceleration sensor 17, a storage 18, and a controller 19, all disposed thereinside.

The user can wear the digital wristwatch 4 by wrapping the holder 24 around the wrist and fixing the holder 24. Because of the holder 24 provided on the main body 23, the digital wristwatch 4 can be easily worn by the user.

While some embodiments of the present disclosure have been described, these embodiments are illustrative only and are not intended to be in any way limiting. The effects described to be achieved by these embodiments represent merely most favorable ones and are not limited to those mentioned with reference to the embodiments described above.

### REFERENCE SIGNS LIST

1, 2, 3 Mobile phone
4 Digital wristwatch
17 Acceleration sensor
18 Storage
19 Controller
20 Light emitter
24 Holder

1. An electronic device comprising at least one controller configured to determine a moving state of a user from a plurality of moving states and to bring a light emitter into a lighting-on state depending on the determined moving state.

2. The electronic device according to claim 1, wherein the at least one controller is configured, after having brought the light emitter into the lighting-on state, to maintain the lighting-on state until an input through an operation part is detected.

3. The electronic device according to claim 1, wherein the at least one controller is configured to:
determine at least one of a walking state or a running state for the moving states; and
when the determined moving state is the walking state or the running state, bring the light emitter into the lighting-on state upon determining that an environment state changes from a bright state to a dark state using an amount of current detected by an illuminance sensor.

4. The electronic device according to claim 1, wherein the at least one controller is configured to bring the light emitter into the lighting-on state depending on the determined moving state upon determining that, using a value detected by a proximity sensor, no object exists within a predetermined distance away from the proximity sensor.

5. A control method of an electronic device, the control method comprising:
determining, by at least one controller, a moving state from a plurality of moving states; and
bringing, by the at least one controller, a light emitter into a lighting-on state depending on the determined moving state.

6. The control method of an electronic device according to claim 5, the control method further comprising:
causing the at least one controller to maintain the lighting-on state until an input through an operation part is detected after the light emitter has been brought into the lighting-on state.

7. A non-transitory storage medium that stores a control program of an electronic device for causing a controller to execute:
determining a moving state from a plurality of moving states; and
bringing a light emitter into a lighting-on state depending on the determined moving state.

8. The non-transitory storage medium that stores the control program of an electronic device according to claim 7, the control program causing the controller to further execute:
maintaining the lighting-on state until an input through an operation part is detected after the light emitter has been brought into the lighting-on state.

9. A control system of an electronic device, comprising:
a light emitter; and
at least one controller configured to determine a moving state of a user from a plurality of moving states and to bring the light emitter into a lighting-on state depending on the determined moving state.
